(19) United States
(12) Patent Application Publication
(10) Pub. No.: US 2018/0251668 A1
(43) Pub. Date: Sep. 6, 2018

(54) CARRIER-FREE TREATMENT PARTICULATES FOR USE IN SUBTERRANEAN FORMATIONS

(71) Applicant: Multi-Chem Group, LLC, San Angelo, TX (US)

(72) Inventors: Fang Wei, Houston, TX (US); Pushkala Krishnamurthy, Pearland, TX (US); Ying Cong Jiang, Pearland, TX (US); Erick J. Acosta, Sugar Land, TX (US); Walter T. Stephens, Houston, TX (US)

(21) Appl. No.: 15/760,047

(22) PCT Filed: Oct. 29, 2015
(86) PCT No.: PCT/US2015/058078

§ 371 Date: Mar. 14, 2018

(51) Int. Cl. C09K 8/66; C09K 8/80; C09K 8/92; E21B 43/26

(52) U.S. Cl. CPC C09K 8/665; C09K 8/805; C09K 8/92; C09K 2208/32; C09K 2208/20; C09K 2208/22; E21B 43/26

(57) ABSTRACT

Certain carrier-free treatment particulates comprising solid treatment chemicals and methods for their formation and of their use in subterranean formations are provided. In one embodiment, the methods comprise: providing a plurality of carrier-free N treatment particulates comprising at least one solid treatment chemical and a coating at least partially disposed around an outer surface of the solid treatment chemical; and introducing the plurality of carrier-free treatment particulates into a well bore penetrating at least a portion of a subterranean formation, wherein the plurality of carrier-free treatment particulates is at least partially consumed in the subterranean formation to create a residual porosity in the portion of the subterranean formation.

### BACKGROUND

The present disclosure relates to methods and compositions for treating subterranean formations.

In hydrocarbon exploration and production, a variety of treatment chemicals may be used to facilitate the production of the hydrocarbons from subterranean formations. These include paraffin inhibitors, gel breakers, dispersing agents, and defoamers, among others. Unfortunately, many treatment chemicals may be adversely affected by exposure to the well bore environment before the chemicals reach their desired destinations in the subterranean formation. This can result in the reaction of the treatment chemical within the well bore, which, depending on the treatment chemical, could affect negatively the production potential of the well. The effectiveness of the treatment chemical may be adversely affected if released prematurely.

In some cases, treatment chemicals such as paraffin inhibitors have been absorbed into pores of silicon or polymer-based carrier materials that may be delivered into a particular area of a subterranean formation. However, such delivery mechanisms may not provide any delay in the release of treatment chemicals into the formation, and thus such chemicals may be depleted by the time the material reaches certain portions of a well. Moreover, the capacity of such mechanisms to carry treatment chemicals may be limited by the porosity of the silicon-based materials. In some cases, mechanisms may be needed to remove the carrier material that remains in the well bore after the treatment chemical has reacted.

### BRIEF DESCRIPTION OF THE DRAWINGS

These drawings illustrate certain aspects of some of the embodiments of the present disclosure, and should not be used to limit or define the claims.

FIG. 1 is a diagram illustrating an example of a fracturing system that may be used in accordance with certain embodiments of the present disclosure.

FIG. 2 is a diagram illustrating an example of a subterranean formation in which a fracturing operation may be performed in accordance with certain embodiments of the present disclosure.

FIG. 3A is a diagram illustrating one embodiment of a treatment particulate of the present disclosure.

FIG. 3B is a diagram illustrating another embodiment of a treatment particulate of the present disclosure.

FIG. 3C is a diagram illustrating another embodiment of a treatment particulate of the present disclosure.

FIG. 3D is a diagram illustrating another embodiment of a treatment particulate of the present disclosure.

While embodiments of this disclosure have been depicted, such embodiments do not imply a limitation on the disclosure, and no such limitation should be inferred. The subject matter disclosed is capable of considerable modification, alteration, and equivalents in form and function, as will occur to those skilled in the pertinent art and having the benefit of this disclosure. The depicted and described embodiments of this disclosure are examples only, and not exhaustive of the scope of the disclosure.

### DESCRIPTION OF CERTAIN EMBODIMENTS

The present disclosure relates to methods and compositions for treating subterranean formations. More particularly, the present disclosure relates to carrier-free treatment particulates comprising solid treatment chemicals and methods for their formation and of their use in subterranean formations.

The treatment particulates of the present disclosure generally comprise discrete particulates comprising one or more treatment chemicals. The treatment particulates of the present disclosure are also coated with one or more layers of materials at least partially disposed around an outer surface of the treatment chemical(s) that temporarily either completely or substantially coat or encapsulate the treatment chemical(s). The treatment particulates of the present disclosure may be introduced into at least a portion of a subterranean formation where the treatment chemical(s) are intended to accomplish or facilitate one or more treatments therein. Once delivered (or as they are being delivered) to the subterranean formation, the coating on the treatment particulates of the present disclosure may begin to dissolve, degrade, or otherwise be removed from the surface of the outermost treatment chemical. Once the coating has at least partially been removed from the treatment particulate, the treatment chemical may interact with components in the subterranean formation, e.g., by diffusing into fluids in contact the treatment particulates. In certain embodiments, the dissolution or degradation of the coating, followed by the diffusion of the treatment chemical may provide a two-step release process to provide a delayed, controlled release of treatment chemical and avoid premature release of the chemical.

In certain embodiments, the treatment particulates of the present disclosure are carrier-free such that the entire treatment particulate is capable of being completely degraded, dissolved, and/or reacted with or in the presence of one or more components to which it is exposed during use, and/or otherwise released into the subterranean formation. Such carrier-free treatment particulates may be completely active or substantially active. As used herein, “carrier-free” and variations of that phrase refer to the lack of a significant portion of an inert and/or an inactive material such as a carrier, a substrate, or the like (e.g., a porous solid particle) in the treatment particulates. Such carriers or substrates commonly are used to encage or entrap the treatment chemicals and often remain in the subterranean formation after the treatment chemicals have been consumed.

Among the many potential advantages to the methods and compositions of the present disclosure, only some of which are alluded to herein, the methods and compositions of the present disclosure may, among other benefits, provide for selective, delayed, and/or controlled release of one or more treatment chemicals in subterranean treatment operations. In some embodiments, the treatment particulates of the present disclosure may be able to resist shear forces in a formation, for example, during fracturing operations, to delay the release of the treatment chemical(s) therein. As used herein, “delayed release” and variations of that phrase may refer to the ability of a treatment particulate of the present disclosure and/or the treatment chemical(s) therein (e.g., by virtue of the coating on the outer surface of a particulate) to maintain its structural integrity during deployment and/or after placement in the formation for some period of time. In certain embodiments, the treatment particulates of the present disclosure may delay the release of a treatment chemical in a subterranean formation for up to about a month.

In some embodiments, a “controlled release” may be provided, among other reasons, to maintain certain concentration levels of a treatment chemical in a fluid over a certain period of time. As used herein, “controlled release” and variations of that phrase may refer to the ability of a treatment particulate of the present disclosure to maintain a certain rate at which the treatment chemical in the treatment particulate is released, e.g., by diffusing into fluids in contact the treatment particulates. In certain embodiments, the treatment particulates of the present disclosure may target a controlled slow release of a treatment chemical over 6 months or more at temperature and pressure conditions in a subterranean formation.

In certain embodiments, the shape of the treatment particulates may contribute to the delayed and/or controlled release of the treatment chemical. In certain embodiments, the shape of the treatment particulates also may at least partially prevent the flowback of the treatment particulates and/or proppant particles to the surface of the subterranean formation.

In some embodiments, the treatment particulates of the present disclosure may be used to deliver larger amounts of treatment chemicals than other means known in the art like porous solid particles, for example, because the treatment particulates of the present disclosure are carrier-free and do not comprise a substantial portion of an inert and/or an inactive material such as a carrier or substrate material. The lack of a significant portion of an inert and/or an inactive material allows for the entire treatment particulate to be consumed such that a residual porosity is created in the well bore (e.g., in a proppant pack) where the treatment particulate was located. As used herein, “residual porosity” and variations of that phrase may refer to a void space remaining in a portion of the subterranean formation. As used herein, “consumed” and variations of that phrase may refer to degraded, dissolved, reacted, and/or otherwise released into the subterranean formation.

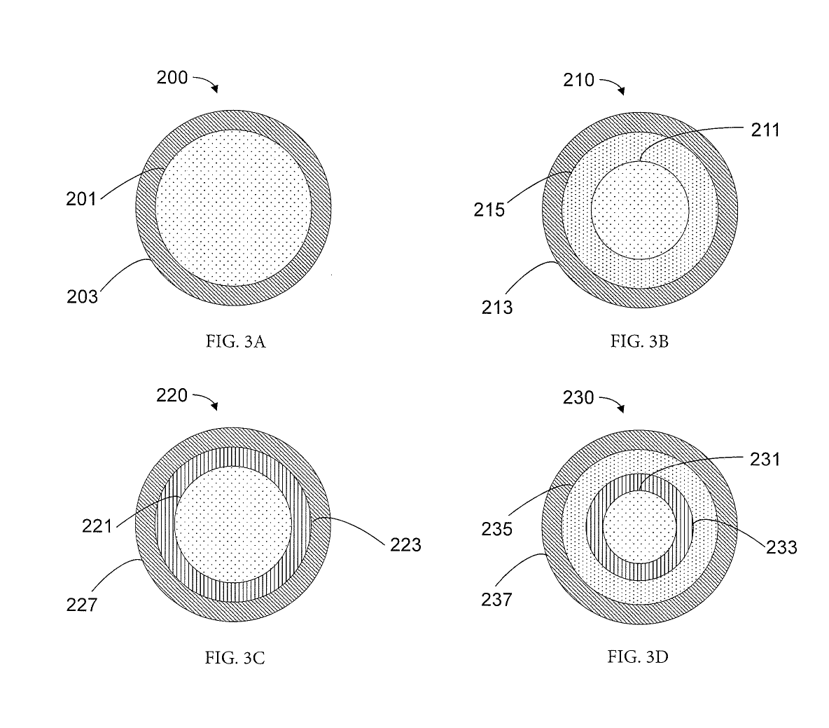

The term “treatment chemical” does not imply any particular action by the chemical or a component thereof. A “treatment chemical” may be any component that is to be placed downhole to perform any desired function, e.g., act upon a portion of the subterranean formation, a tool, or a composition located downhole. Any treatment chemical that is useful down hole and that does not adversely react with the coating may be used as a treatment chemical in the present disclosure. The treatment chemical is preferably in solid form. Cross-sectional views of example embodiments of the treatment particulates of the present disclosure are shown in FIG. 3A-D. Referring now to FIG. 3A, treatment particulate 200 includes a solid treatment chemical 201. Treatment particulate 200 also includes a coating 203 disposed around the outermost surface of the solid treatment chemical 201. While coating 203 is shown as completely encapsulating the solid treatment chemical 201, the coating 203 in other embodiments of the present disclosure may only cover some portion of the outer surface of the solid treatment chemical 201.

Referring now to FIG. 3B, another embodiment of a treatment particulate 210 of the present disclosure is shown. Like treatment particulate 200 of FIG. 3A, treatment particulate 210 includes a first solid treatment chemical 211 and a coating 213. However, treatment particulate 210 also includes a second solid treatment chemical 215 disposed around the outermost surface of the first solid treatment chemical 211. The coating 213 is disposed around the outermost surface of the second solid treatment chemical 215. In such embodiments, the coating 213 may at least partially dissolve and/or degrade in certain environments or conditions (e.g., aqueous environments), which may result in the release of at least a portion of the second solid treatment chemical 215 into the subterranean formation. The release of at least a portion of the second solid treatment chemical 215 may result in the release of at least a portion of the first solid treatment chemical 211 into the subterranean formation.

Another embodiment of a treatment particulate of the present disclosure is shown in FIG. 3C. Referring now to FIG. 3C, similar to the embodiment shown in FIG. 3A, treatment particulate 220 includes a solid treatment chemical 221 and a coating 223 disposed around the outermost surface of the solid treatment chemical 221. In this embodiment, treatment particulate 220 also includes a second coating 227 that is disposed around the outermost surface of the first coating 223. In certain of these embodiments, the first and second coatings may, among other benefits, enhance the durability and/or stability of treatment particulate 220, and/or may be formulated to enhance its performance where the treatment particulate 220 may be subjected to multiple different environments and/or conditions in a subterranean formation. For example, the second coating 227 may prevent the premature release of the treatment chemical 221 in certain types of environments in which the second coating 227 will not degrade or dissolve (e.g., aqueous environments), while the first coating 223 may prevent the premature release of the treatment chemical 221 in certain types of environments in which the first coating 223 will not degrade or dissolve (e.g., oil-based environments).

Another embodiment of a treatment particulate of the present disclosure is shown in

FIG. 3D. Referring now to FIG. 3D, similar to the embodiments shown in FIGS. 3A and 3C, treatment particulate 230 includes a solid treatment chemical 231 and a coating 233 that is disposed around the outermost surface of the solid treatment chemical 231. In this embodiment, treatment particulate 230 also includes a second treatment chemical 235 and another coating 237 that is disposed around the outermost surface of the second treatment chemical 235. The first treatment chemical 231 and its coating 233 are surrounded by the second treatment chemical 235 and its coating 237.

Continuing to refer to FIG. 3D as an illustrative example, in certain embodiments, the second treatment chemical 235 and/or coating 237 may comprise the same materials as solid treatment chemical 231 and coating 233, respectively. In other embodiments, one or more of those elements may differ from their counterparts (e.g., treatment chemical 235 may be a different treatment chemical from treatment chemical 231). In certain of these embodiments, the various components of treatment particulate 230 may be formulated, among other purposes, to allow for the selective release of multiple solid treatment chemicals (or different amounts of the same treatment chemical) in a single area of the formation at different points in time. For example, coating 237 may be selected to at least partially dissolve and/or degrade in certain environments or conditions (e.g., aqueous environments) while coating 233 does not dissolve or degrade in that environment or in those conditions. As a result, treatment chemical 235 may be released in that environment or condition while treatment chemical 231 is not. At some later point in time, after coating 237 has at least partially dissolved and/or degraded, treatment particulate 230 may be exposed to an environment or condition in which coating 233 will at least partially dissolve and/or degrade, and thus treatment chemical 231 may be released at that point.

Any method known in the art may be used to form the solid treatment chemicals of the present disclosure. In some embodiments, the solid treatment chemicals may be formed from at least one treatment chemical by an extrusion process and/or a milling process. In certain embodiments, the solid treatment chemicals may be formed by co-extruding two or more treatment chemicals. In certain embodiments, the solid treatment chemicals (either prior to or after coating) may be cut or ground to a size and/or shape that are similar to other particulates (e.g., proppant particles) that are to be used in the same treatment fluid and/or subterranean formation.

The coating material may be applied to the outer surface of a solid chemical treatment to form a treatment particulate of the present disclosure using any means or technique known in the art, including, but not limited to, fluidized bed processes, pan coating processes, Wurster processes, top spray processes, spinning disk atomization processes, chemical encapsulation processes, extrusion, and the like. In extrusion methods, the coating may be co-extruded with one or more treatment chemicals such that the coating is disposed on the surface of the treatment chemical. In spray coating methods, the solid treatment chemicals will be suspended as particulates within a chamber and a coating sprayed onto the surface. In certain embodiments, by controlling the spray time, various coating thickness can be applied, among other reasons, to tailor the performance of the coated product. Examples of chemical coating techniques that may be suitable for coating the solid treatment chemicals of the present disclosure may include, but are not limited to, in situ solution polymerization techniques, interfacial polymerization techniques, emulsion polymerization techniques, simple and complex coacervation, and the like.

The shape of the treatment particulates of the present disclosure also may provide a further variable through which to control the diffusion of the treatment chemicals into fluids in contact with the treatment particulates. In certain embodiments, the treatment particulates may be of a cylindrical or rod-like shape. In certain embodiments, the treatment particulates may be of a substantially spherical shape. In some embodiments, a combination of cylindrical and spherical treatment particulates may be utilized.

The size of the treatment particulates of the present disclosure may provide a further variable through which to control the diffusion of the treatment chemicals into fluids in contact with the treatment particulates. In certain embodiments, the size of the treatment particulates of the present disclosure may be such that the treatment particulates are compatible with other particulates, for example, proppant particles. In certain embodiments, the treatment particulates having a cylindrical or rod-like shape may be from about 0.1 mm to about 5 mm in length. In some embodiments, the length of the treatment particulates having a cylindrical or rod-like shape may be from about 0.1 mm to about 1 mm, in other embodiments, from about 1 mm to about 2 mm, in other embodiments, from about 2 mm to about 3 mm, in other embodiments, from about 3 mm to about 4 mm, and in other embodiments, from about 4 mm to about 5 mm.

In certain embodiments, the elongated shape of certain treatment particulates of the present disclosure having a rod-like or cylindrical shape may increase the void spaces between the treatment particulates and/or the proppant particulates as compared to the treatment particulates having a substantially spherical shape. The increase in void spaces may in turn increase the conductivity of the proppant pack and/or may reduce the non-Darcy flow effect (a characterization of fluid flow that accounts for the turbulence generated as the oil or natural gas flows through the proppant pack). Non-Darcy fluid flow is sometimes problematic because it may strip the deposited treatment particulates and/or proppant particles from a fracture within the well bore, thus causing them to flow back to the well bore and/or to the surface of the subterranean formation with natural gas or oil being produced. In particular, it is believed that the use of a least some treatment particulates having a rod-like or cylindrical shape may reduce the turbulence component of the non-Darcy flow effect as compared to the use of only treatment particulates having a substantially spherical shape. Therefore, the shape of the treatment particulates of the present disclosure, in some embodiments, may at least partially allow the treatment particulates and/or proppant particles (or a substantial portion thereof) to remain in place in the formation and prevent the flowback of the treatment particulates and/or proppant particles into the well bore and/or to the surface of the subterranean formation. The prevention of flowback may, among other benefits, ensure that the treatment particulates and/or proppant particles reach their intended location in the formation and perform their intended function.

As exemplified in FIG. 3A-D, the treatment particulates of the present disclosure may comprise one or more solid treatment chemicals and/or one or more coatings in any sequence, order, or combination. The one or more solid treatment chemicals and/or one or more coatings may be of any thickness appropriate for a particular application of the present disclosure, which a person of skill in the art with the benefit of this disclosure will recognize.

Any treatment chemical in solid form that is useful downhole may be used as a solid treatment chemical in the present disclosure. Examples of treatment chemicals that may be suitable for certain embodiments of the present disclosure include, but are not limited to, chelating agents (e.g., EDTA, citric acid, polyaspartic acid), scale inhibitors, gel breakers, dispersants, paraffin inhibitors, asphaltene inhibitors, hydrate inhibitors, corrosion inhibitors, demulsifiers, foaming agents, defoamers, delinkers, crosslinkers, surfactants, salts, acids, catalysts, clay control agents, biocides, friction reducers, flocculants, H₂S scavengers, CO₂ scavengers, oxygen scavengers, lubricants, viscosifiers, relative permeability modifiers, surfactants, wetting agents, filter cake removal agents, antifreeze agents and any derivatives and/or combinations thereof.

The coatings in the treatment particulates of the present disclosure may comprise any materials known in the art suitable for forming coatings on surfaces, including, but not limited to, polymeric materials. These coatings may be hydrophobic or hydrophilic in nature, depending on the intended use of the treatment particulate. Examples of materials that may be used to form coatings in the treatment particulates of the present disclosure include, but are not limited to, degradable polymers, copolymers, synthetic or natural occurring resins, nylon, waxes, drying oils, polyurethanes, polyacrylics, silicate materials, glass materials, inorganic durable materials, phenolics, biopolymers (e.g., cellulose), polysaccharides, hydrocolloids, gums, and any derivatives and/or combinations thereof. The coating may be of any thickness appropriate for a particular application of the present disclosure, which a person of skill in the art with the benefit of this disclosure will recognize.

In certain embodiments, the treatment particulates may be mixed with a treatment fluid. The treatment fluids used in the methods and compositions of the present disclosure may comprise any base fluid known in the art, including aqueous base fluids, non-aqueous base fluids, and any combinations thereof. The term “base fluid” refers to the major component of the fluid (as opposed to components dissolved and/or suspended therein), and does not indicate any particular condition or property of that fluid such as its mass, amount, pH, etc. Aqueous fluids that may be suitable for use in the methods of the present disclosure may comprise water from any source. Such aqueous fluids may comprise fresh water, salt water (e.g., water containing one or more salts dissolved therein), brine (e.g., saturated salt water), seawater, or any combination thereof. In most embodiments of the present disclosure, the aqueous fluids comprise one or more ionic species, such as those formed by salts dissolved in water. For example, seawater and/or produced water may comprise a variety of divalent cationic species dissolved therein.

In certain embodiments, the density of the aqueous fluid can be adjusted, among other purposes, to provide additional particulate transport and suspension in the compositions of the present disclosure. In certain embodiments, the pH of the aqueous fluid may be adjusted (e.g., by a buffer or other pH adjusting agent) to a specific level, which may depend on, among other factors, the types of viscosifying agents, acids, and other additives included in the fluid. One of ordinary skill in the art, with the benefit of this disclosure, will recognize when such density and/or pH adjustments are appropriate.

Examples of non-aqueous fluids that may be suitable for use in the methods of the present disclosure include, but are not limited to, oils, hydrocarbons, organic liquids, and the like. In certain embodiments, the treatment fluids may comprise a mixture of one or more fluids and/or gases, including, but not limited to, emulsions, foams, and the like.

In certain embodiments, the treatment fluids used in the methods and compositions of the present disclosure optionally may comprise any number of additional additives other than the treatment particulates of the present disclosure. Examples of such additional additives include, but are not limited to, salts, surfactants, acids, proppant particulates, diverting agents, fluid loss control additives, gas, nitrogen, carbon dioxide, surface modifying agents, tackifying agents, foamers, corrosion inhibitors, scale inhibitors, catalysts, clay control agents, biocides, friction reducers, antifoam agents, bridging agents, flocculants, additional H₂S scavengers, CO₂ scavengers, oxygen scavengers, lubricants, additional viscosifiers, breakers, weighting agents, relative permeability modifiers, resins, wetting agents, coating enhancement agents, filter cake removal agents, antifreeze agents (e.g., ethylene glycol), and the like. In certain embodiments, one or more of these additional additives (e.g., a crosslinking agent) may be added to the treatment fluid and/or activated after the viscosifying agent has been at least partially hydrated in the fluid. A person skilled in the art, with the benefit of this disclosure, will recognize the types of additives that may be included in the fluids of the present disclosure for a particular application.

The present disclosure in some embodiments provides method for using the treatment particulates to carry out a variety of subterranean treatments. In certain embodiments, the treatment particulates may be introduced into a well bore penetrating at least a portion of a subterranean formation. In some embodiments, the treatment particulates may be introduced directly down hole, for example, into the annulus. In other embodiments, the treatment particulates may be mixed with a treatment fluid (for example, a fracturing fluid) and the treatment fluid may then be introduced into a well bore penetrating at least a portion of a subterranean formation. In certain embodiments, the treatment particulates may be mixed with a treatment fluid and a plurality of proppant particles. In such embodiments, the treatment particulates and the proppant particles may be deposited into at least a portion of the subterranean formation to form a proppant pack.

In certain embodiments, the coating may delay and/or control the release of the solid treatment chemical(s) in the subterranean formation. In certain embodiments, the coating may begin to dissolve, degrade, or otherwise be removed from the surface of the outermost treatment chemical due to the environment and/or conditions in a subterranean formation (e.g., temperature, pressure, contact with fluids). Once the coating has at least partially been removed from the treatment particulate, the solid treatment chemical may be released into the formation and/or interact with components in the subterranean formation, e.g., by diffusing into fluids in contact the treatment particulates. In certain embodiments, the treatment particulates may comprise two of more solid treatment chemicals and the two or more treatment chemicals may react in situ within the subterranean formation to form a different treatment chemical. For example, a first solid treatment chemical may be released into the formation and then sometime after a second solid treatment chemical may be released into the formation and may react with the first solid treatment chemical.

Because the treatment particulates of the present disclosure are carrier-free (i.e., lack a carrier, a substrate, or the like), the treatment particulates may be completely consumed over some period of time. Thus, in certain embodiments, a residual porosity may be created in at least a portion of the subterranean formation, for example, in a proppant pack, as the coating begins to dissolve, degrade, or otherwise be removed from the surface of the solid treatment chemical and the solid treatment chemical is consumed.

The present disclosure in some embodiments provides methods for using the treatment fluids to carry out a variety of subterranean treatments, including, but not limited to, hydraulic fracturing treatments, acidizing treatments, and drilling operations. In some embodiments, the treatment fluids of the present disclosure may be used in treating a portion of a subterranean formation, for example, in acidizing treatments such as matrix acidizing or fracture acidizing. In certain embodiments, a treatment fluid may be introduced into a subterranean formation. In some embodiments, the treatment fluid may be introduced into a well bore that penetrates a subterranean formation. In some embodiments, the treatment fluid may be introduced at a pressure sufficient to create or enhance one or more fractures within the subterranean formation (e.g., hydraulic fracturing).

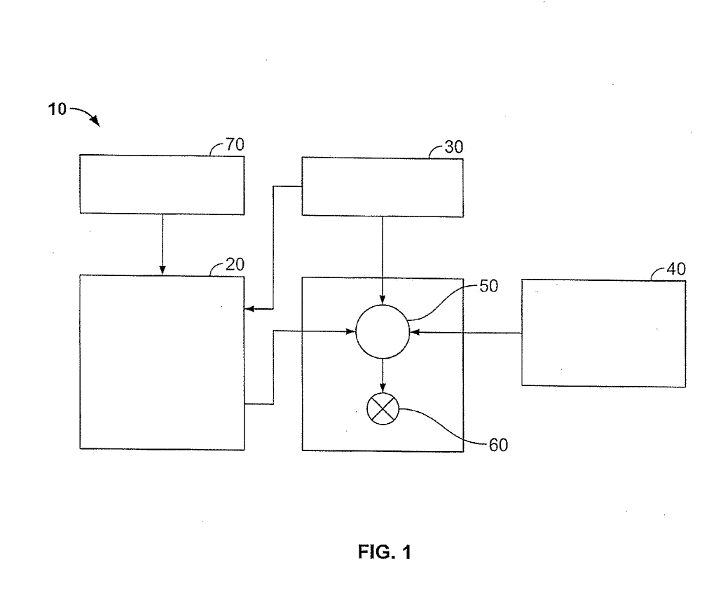

Certain embodiments of the methods and compositions disclosed herein may directly or indirectly affect one or more components or pieces of equipment associated with the preparation, delivery, recapture, recycling, reuse, and/or disposal of the disclosed compositions. For example, and with reference to FIG. 1, the disclosed methods and compositions may directly or indirectly affect one or more components or pieces of equipment associated with an exemplary fracturing system 10, according to one or more embodiments. In certain instances, the system 10 includes a fracturing fluid producing apparatus 20, a fluid source 30, a proppant source 40, and a pump and blender system 50 and resides at the surface at a well site where a well 60 is located. In certain instances, the fracturing fluid producing apparatus 20 combines a gel pre-cursor with fluid (e.g., liquid or substantially liquid) from fluid source 30, to produce a hydrated fracturing fluid that is used to fracture the formation. The hydrated fracturing fluid can be a fluid for ready use in a fracture stimulation treatment of the well 60 or a concentrate to which additional fluid is added prior to use in a fracture stimulation of the well 60. In other instances, the fracturing fluid producing apparatus 20 can be omitted and the fracturing fluid sourced directly from the fluid source 30. In certain instances, the fracturing fluid may comprise water, a hydrocarbon fluid, a polymer gel, foam, air, wet gases and/or other fluids.

The proppant source 40 can include a proppant for combination with the fracturing fluid. In certain embodiments, one or more treatment particulates of the present disclosure may be provided in the proppant source 40 and thereby combined with the fracturing fluid with the proppant. The system may also include additive source 70 that provides one or more additives (e.g., gelling agents, weighting agents, and/or other optional additives) to alter the properties of the fracturing fluid. For example, the other additives may be provided in additive source 70 can be included to reduce pumping friction, to reduce or eliminate the fluid's reaction to the geological formation in which the well is formed, to operate as surfactants, and/or to serve other functions. In certain embodiments, the other additives may be provided in additive source 70 may include one or more treatment particulates of the present disclosure.

The pump and blender system 50 receives the fracturing fluid and combines it with other components, including proppant from the proppant source 40 and/or additional fluid from the additive source 70. The resulting mixture may be pumped down the well 60 under a pressure sufficient to create or enhance one or more fractures in a subterranean zone, for example, to stimulate production of fluids from the zone. Notably, in certain instances, the fracturing fluid producing apparatus 20, fluid source 30, and/or proppant source 40 may be equipped with one or more metering devices (not shown) to control the flow of fluids, proppant particles, and/or other compositions to the pumping and blender system 50. Such metering devices may permit the pumping and blender system 50 can source from one, some or all of the different sources at a given time, and may facilitate the preparation of fracturing fluids in accordance with the present disclosure using continuous mixing or “on-the-fly” methods. Thus, for example, the pumping and blender system 50 can provide just fracturing fluid into the well at some times, just proppant particles at other times, and combinations of those components at yet other times.

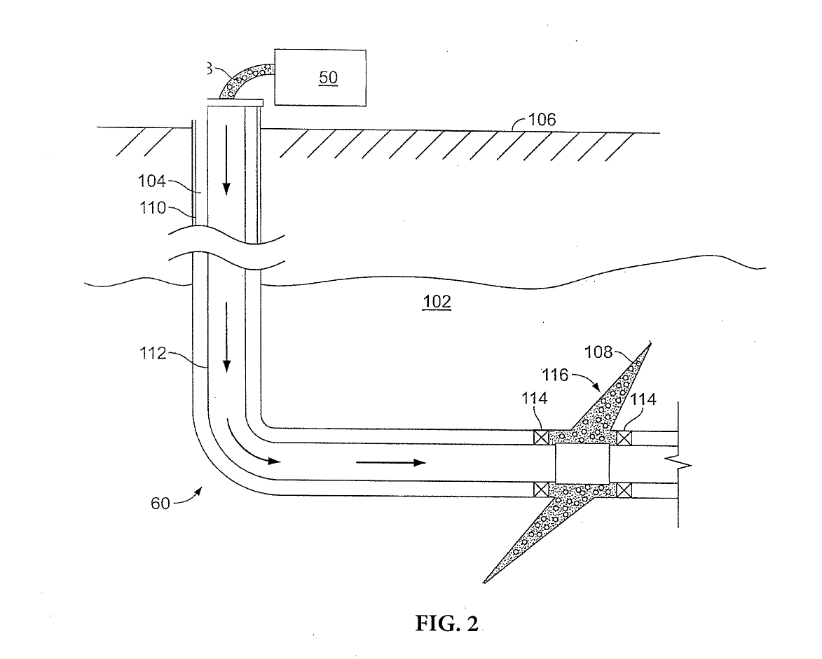

FIG. 2 shows the well 60 during a fracturing operation in a portion of a subterranean formation of interest 102 surrounding a well bore 104. The well bore 104 extends from the surface 106, and the fracturing fluid 108 is applied to a portion of the subterranean formation 102 surrounding the horizontal portion of the well bore. Although shown as vertical deviating to horizontal, the well bore 104 may include horizontal, vertical, slant, curved, and other types of well bore geometries and orientations, and the fracturing treatment may be applied to a subterranean zone surrounding any portion of the well bore. The well bore 104 can include a casing 110 that is cemented or otherwise secured to the well bore wall. The well bore 104 can be uncased or include uncased sections. Perforations can be formed in the casing 110 to allow fracturing fluids and/or other materials to flow into the subterranean formation 102. In cased wells, perforations can be formed using shape charges, a perforating gun, hydro jetting and/or other tools.

The well is shown with a work string 112 depending from the surface 106 into the well bore 104. The pump and blender system 50 is coupled a work string 112 to pump the fracturing fluid 108 into the well bore 104. The working string 112 may include coiled tubing, jointed pipe, and/or other structures that allow fluid to flow into the well bore 104. The working string 112 can include flow control devices, bypass valves, ports, and or other tools or well devices that control a flow of fluid from the interior of the working string 112 into the subterranean zone 102. For example, the working string 112 may include ports adjacent the well bore wall to communicate the fracturing fluid 108 directly into the subterranean formation 102, and/or the working string 112 may include ports that are spaced apart from the well bore wall to communicate the fracturing fluid 108 into an annulus in the well bore between the working string 112 and the well bore wall.

The working string 112 and/or the well bore 104 may include one or more sets of packers 114 that seal the annulus between the working string 112 and well bore 104 to define an interval of the well bore 104 into which the fracturing fluid 108 will be pumped. FIG. 2 shows two packers 114, one defining an uphole boundary of the interval and one defining the downhole end of the interval. When the fracturing fluid 108 is introduced into well bore 104 (e.g., in FIG. 2, the area of the well bore 104 between packers 114) at a sufficient hydraulic pressure, one or more fractures 116 may be created in the subterranean zone 102. The proppant particulates (and/or treatment particulates of the present disclosure) in the fracturing fluid 108 may enter the fractures 116 where they may remain after the fracturing fluid flows out of the well bore. These proppant particulates may “prop” fractures 116 such that fluids may flow more freely through the fractures 116.

While not specifically illustrated herein, the disclosed methods and compositions may also directly or indirectly affect any transport or delivery equipment used to convey the compositions to the fracturing system 10 such as, for example, any transport vessels, conduits, pipelines, trucks, tubulars, and/or pipes used to fluidically move the compositions from one location to another, any pumps, compressors, or motors used to drive the compositions into motion, any valves or related joints used to regulate the pressure or flow rate of the compositions, and any sensors (i.e., pressure and temperature), gauges, and/or combinations thereof, and the like.

An embodiment of the present disclosure is a method comprising: providing a plurality of carrier-free treatment particulates comprising at least one solid treatment chemical and a coating at least partially disposed around an outer surface of the solid treatment chemical; and introducing the plurality of carrier-free treatment particulates into a well bore penetrating at least a portion of a subterranean formation, wherein the plurality of carrier-free treatment particulates is at least partially consumed in the subterranean formation to create a residual porosity in the portion of the subterranean formation.

Another embodiment of the present disclosure is a method comprising: forming a particulate comprising a solid treatment chemical by subjecting the treatment chemical to an extrusion process, a milling process, or any combination thereof; placing a coating on an outer surface of the solid treatment chemical particulate to form a carrier-free treatment particulate; and introducing the carrier-free treatment particulate into a well bore penetrating at least a portion of a subterranean formation.

Another embodiment of the present disclosure is a treatment particulate composition comprising: a first solid treatment chemical; a second solid treatment chemical disposed around an outer surface of the first solid treatment chemical; and a coating disposed around an outer surface of the second solid treatment chemical, wherein the treatment particulate is carrier-free.

Therefore, the present disclosure is well adapted to attain the ends and advantages mentioned as well as those that are inherent therein. The particular embodiments disclosed above are illustrative only, as the present disclosure may be modified and practiced in different but equivalent manners apparent to those skilled in the art having the benefit of the teachings herein. While numerous changes may be made by those skilled in the art, such changes are encompassed within the spirit of the subject matter defined by the appended claims. Furthermore, no limitations are intended to the details of construction or design herein shown, other than as described in the claims below. It is therefore evident that the particular illustrative embodiments disclosed above may be altered or modified and all such variations are considered within the scope and spirit of the present disclosure. In particular, every range of values (e.g., “from about a to about b,” or, equivalently, “from approximately a to b,” or, equivalently, “from approximately a-b”) disclosed herein is to be understood as referring to the power set (the set of all subsets) of the respective range of values. The terms in the claims have their plain, ordinary meaning unless otherwise explicitly and clearly defined by the patentee.

What is claimed is:

1. A method comprising:
providing a plurality of carrier-free treatment particulates comprising at least one solid treatment chemical and a coating at least partially disposed around an outer surface of the solid treatment chemical; and
introducing the plurality of carrier-free treatment particulates into a well bore penetrating at least a portion of a subterranean formation,
wherein the plurality of carrier-free treatment particulates is at least partially consumed in the subterranean formation to create a residual porosity in the portion of the subterranean formation.

2. The method of claim 1 further comprising:
allowing the coating to delay the release of the solid treatment chemical in the subterranean formation.

3. The method of claim 1 wherein the solid treatment chemical is formed by extrusion, milling, and any combination thereof.

4. The method of claim 1 wherein at least a portion of the carrier-free treatment particulates are of a shape selected from the group consisting of: a cylinder, a rod, a sphere, and any combination thereof.

5. The method of claim 4 wherein at least a portion of the carrier-free treatment particulates have a cylinder or rod shape having a length of from about 0.1 mm to about 5 mm.

6. The method of claim 5 wherein at least a portion of the carrier-free treatment particulates remains in the portion of the subterranean formation and is does not flow back into the well bore.

7. The method of claim 1 wherein the solid treatment chemical comprises at least one chemical additive selected from the group consisting of: a paraffin inhibitor, an asphaltene inhibitor, a hydrate inhibitor, a scale inhibitor, a biocide, a surfactant, a corrosion inhibitor, an H₂S scavenger, a demulsifier, and any combination thereof.

8. The method of claim 1 wherein the carrier-free treatment particulate comprises at least two solid treatment chemicals, and the method further comprising allowing the at least two solid treatment chemicals to react in situ within the portion of the subterranean formation to form a different treatment chemical.

9. The method of claim 1 wherein:
the method further comprises mixing the carrier-free treatment particulates with a fracturing fluid and a plurality of proppant particles, and introducing the plurality of proppant particles into the well bore; and
introducing the plurality of carrier-free treatment particulates into the well bore comprises introducing the fracturing fluid into a well bore penetrating at least a portion of a subterranean formation at or above a pressure sufficient to create or enhance at least one fracture in at least a portion of the subterranean formation.

10. The method of claim 9 wherein the fracturing fluid is introduced into the subterranean formation using one or more pumps.

11. The method of claim 9 further comprising depositing the carrier-free treatment particulates and proppant particles in at least a portion of a fracture in the subterranean formation to form a proppant pack.

12. The method of claim 11 wherein the residual porosity is created in the proppant pack.

13. The method of claim 9 wherein at least a portion of the proppant particulates remains in the portion of the subterranean formation and does not flow back into the well bore.

14. A method comprising:
forming a particulate comprising a solid treatment chemical by subjecting the treatment chemical to an extrusion process, a milling process, or any combination thereof;
placing a coating on an outer surface of the solid treatment chemical particulate to form a carrier-free treatment particulate; and
introducing the carrier-free treatment particulate into a well bore penetrating at least a portion of a subterranean formation.

15. The method of claim 14 wherein forming the solid treatment chemical comprises co-extruding two or more treatment chemicals.

16. The method of claim 14 wherein the coating is placed on the outer surface of the solid treatment chemical by co-extruding the solid treatment chemical and the material that forms the coating.

17. The method of claim 16 further comprising allowing the coating to delay the release of the solid treatment chemical in the subterranean formation.

18. The method of claim 14 wherein:
The method further comprises mixing a plurality of carrier-free treatment particulates with a fracturing fluid; and
introducing the carrier-free treatment particulate into a well bore comprises introducing the fracturing fluid into a well bore penetrating at least a portion of a subterranean formation at or above a pressure sufficient to create or enhance at least one fracture in at least a portion of the subterranean formation.

19. A treatment particulate comprising:
a first solid treatment chemical;
a second solid treatment chemical disposed around an outer surface of the first solid treatment chemical; and
a coating disposed around an outer surface of the second solid treatment chemical, wherein the treatment particulate is carrier-free.

20. The treatment particulate of claim 19 further comprising:
a second coating disposed around an outer surface of the first solid treatment chemical, wherein the second solid treatment chemical disposed around the outer surface of the second coating.
